(19) United States
(12) Patent Application Publication
(10) Pub. No.: US 2004/0162978 A1
(43) Pub. Date: Aug. 19, 2004

(54) Firmware developer user interface

(76) Inventors: Jason W. Reasor, Frisco, TX (US); Bradley G. Culter, Dallas, TX (US); Greg Albrecht, Plano, TX (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/368,269

(22) Filed: Feb. 17, 2003

(51) Int. Cl. G06F 15/177; G06F 9/44

(52) U.S. Cl. 713/2; 719/328

(57) ABSTRACT

A method for providing a firmware developer user interface in a multi-nodal computer system comprises invoking a firmware developer user interface during boot of a multi-nodal computer system, dumping a process state for the boot to a console, handing-off flow control of the boot to the developer user interface and accepting at least one command to firmware of the multi-nodal computer system via the console and the developer user interface.

### CROSS-REFERENCE TO RELATED APPLICATIONS

The present invention is related to concurrently filed, co-pending and commonly assigned U.S. patent application Ser. No. [Attorney Docket No. 100200765-], entitled “FIRMWARE DEVELOPER USER INTERFACE WITH BREAK COMMAND POLLING”; and U.S. patent application Ser. No. Attorney Docket No. 200207437-1], entitled “REMOTE ACCESS TO A FIRMWARE DEVELOPER USER INTERFACE”, the disclosures of which are incorporated herein by reference in their entireties.

### BACKGROUND

Many failure modes are possible in existing multi-nodal or cellular architecture computer systems. There are failure modes in multi-nodal computer systems that are not well supported within existing boot or initial program load (IPL) firmware. Some of these failure modes arise when a multi-nodal computer system is booting. In such a system, each system cell, or node, boots at a firmware level within the cell. The firmware of each cell then starts communicating with the firmware of other cells, with the goal of making one system from the server OS's point of view, such that the cells are transparent, externally presenting the system as a single computer. This joining of cells is commonly referred to as rendezvous. Due to some sort of failure, such as a machine check abort (MCA), a cell or multiple cells may not make the rendezvous. In existing systems, that cell, or those cells, reboot and is/are unavailable to the system. In other words, in existing multi-nodal systems, if a cell does not make rendezvous it is left out of the system. As a result, a particular cell has a resource present in a cell that the system OS requires, and that cell fails to make rendezvous, the boot of the entire existing multi-nodal system may fail. Such a required resource may be the operating system disk drive, console universal asyncironous receiver/transmitter (UART) connector, local area network (LAN) system boot card, or the like.

Existing firmware user interfaces, designed to be accessed under normal boot conditions and/or from a system-wide perspective, have been implemented, but these interfaces cannot be accessed at the cell level in the event of a system crash, or cell boot abort. Typically, for multi-nodal or cellular architecture server-class computers, when an error state arises during system start-up or boot, an available interactive interface with the system, known as the console, may be invoked. Firmware specialist engineers or developers are often involved in the diagnosis of boot firmware related problems. However, a firmware specialist or developer is not typically able to gain access to the firmware via this console. In existing multi-nodal computers, firmware runs at a very low level in each node and the console does not allow access into the cells that fail to reach system rendezvous.

External tools have been used in the past to gather system information at the time of a crash. For some existing systems, these external tools are used to pull information from the system in the event of a fatal error, often themselves requiring a reboot of the system to diagnose it. However, such interfaces are typically only available at a system level. Also, these tools must be designed to work correctly with the system under test. Problematically, these tools also require their own computer system on which to be run in order to provide useful information.

### SUMMARY

An embodiment of a method for providing a firmware developer user interface in a multi-nodal computer system comprises invoking a firmware developer user interface during boot of a multi-nodal computer system, dumping a process state for the boot to a console, handing-off flow control of the boot to the developer user interface and accepting at least one command to firmware of the multi-nodal computer system via the console and the developer user interface.

An embodiment of a firmware developer user interface for a multi-nodal computer system comprises means for receiving a dump of boot process status of at least one cell of a multi-nodal computer system, means for displaying the dump on a console of the system, means for controlling flow of boot of at least one cell of the multi-nodal computer system and means for directing commands to firmware of at least one cell of the multi-nodal computer system from the console.

Another embodiment of a method for providing a firmware developer user interface in a multi-nodal computer system comprises invoking a firmware developer user interface upon boot failure of a cell in a multi-nodal computer system, dumping a process state for the boot of the cell to a console of the system, handing-off flow control of the boot of the cell to the developer user interface, and accepting at least one command to firmware of the cell via the console and the developer user interface.

Another embodiment of a firmware developer user interface for a multi-nodal computer system comprises means for receiving a dump of boot process status of a cell of a multi-modal computer system, means for displaying the dump on a console of the system, means for controlling flow of boot of the cell, and means for directing commands to firmware of the cell from the console.

### BRIEF DESCRIPTION OF THE DRAWINGS

FIG. 1 is a diagrammatic view of a multi-nodal computer system employing a developer user interface;

FIG. 2 is a diagrammatic view of a developer user interface;

FIG. 3 is a flowchart showing a method for providing a firmware developer user interface in a multi-nodal computer system; and

FIG. 4 is a flowchart of boot of a multi-nodal computer system showing invocation of a developer user interface upon boot failure.

### DETAILED DESCRIPTION

The present disclosure is, in general, directed to systems and methods which provide a developer user interface (DUI) for one or more cells in a multi-cell computer system upon boot failure or when called for by an engineer, developer or technician user during boot. From a developer's perspective, the DUI provides access to manipulate source level debugging as well as visibility into and control over data structures and other information the firmware has created in order to boot the cell or system properly. From a support engineer's perspective, the DUI provides an opportunity to deconfigure central processing units (CPU)s, deconfigure memory, take hardware out of the boot process for a cell, or take other corrective action(s), so a cell and ultimately the system can boot. By implementing one embodiment of the DUI, a user, such as a developer or a firmware engineer, need only have console access. The firmware itself may provide a diagnostic capability as well.

One disclosed embodiment of the DUI is particularly well suited for use in an INTEL® ITANIUM™ processor family (IPF) based multi-nodal computer system. However, as one skilled in the art will appreciate, other embodiments of the DUI may be used in any number of multi-nodal computer systems and may be implemented across multiple platforms. Some embodiments of the DUI may provide interactive initiation control enabling interaction with the DUI while the system or cell is still booting.

In the case of a boot failure, such as a machine check abort (MCA) in a multi-nodal or cellular architecture computer system, it is important for a firmware engineer or developer to have access to appropriate information in order to diagnose the problem and act accordingly. In one embodiment of the present invention this is accomplished by passing flow of control to a low-level firmware DUI in the event of a fatal error. After saving machine state and arriving at a DUI prompt, the DUT enables an engineer or developer to issue commands, view error logs, view or modify hardware and firmware states, and inject data to avoid problems on subsequent boots. This low-level firmware interface provides such support on a per-cell basis. This allows the engineer or developer to debug a problem on a particular cell without impacting performance and function of other cells or the system. The interface may be provided on each cell through a platform dependent hardware (PDH) console interface. The engineer or developer in one embodiment is provided the flexibility of treating each cell as a separate “system” for debugging purposes. By providing debug capabilities on a per-cell level, the rest of the system can continue to boot while an individual cell's resources are debugged.

In cells employing one DUI embodiment, external tools are not required to gather system information. Information can be injected into the cell or the system without a dependency on external tools. Whereas, one embodiment of the DUI is a direct window into the firmware of a cell or the system, extended system information may be gathered. In one embodiment, the DUI is deployed on an individual cell level and does not depend upon the existence of a system-wide input/output (I/O) console for support. Each cell provides its own dedicated interface. However, system-wide console access may also be provided after cell rendezvous, prior to hand off to the OS system. One embodiment of the present system directly supports debugging of a truant cell, while normally functioning cells rendezvous and boot the operating system. In existing multi-nodal systems, the operating system, not aware of the missing cell(s), cannot be used to assist in debugging the truant cell(s). In such a system, the DUI provides direct interactive access to each truant cell while the operating system continues to function.

An early access window into a high-end server system's firmware, before boot completion, may be provided by the DUI. In one embodiment an interactive DUI is available before core system firmware passes control to adapters or boot handlers. This window into the boot firmware during the boot process is very helpful; instead of waiting for the entire boot process to complete in order to reach an end user prompt, functionality is available beforehand. A developer or engineer may view or modify the hardware configuration or display information from the firmware interface table (FIT). The interactive DUI also may provide a qualification base for code in development. For example, test drivers may be run from the DUI prompt in accordance with an embodiment of the present invention.

In some embodiments the DUI may enable: display and modification of options, such as run-time parameters, nonvolatile random access memory (NVRAM) flags, and the like; display of hardware descriptions; listing of fault tree topology in a format similar to a file system, enabling command line functions such as “change directory”(cd), “list” (ls), or the like; display and modification of bits in hardware registers; configuration of hardware such as CPUs, memory, or the like; configuration of firmware components; display of the FIT, registry and component table; acting as a qualification platform by enabling developer tests of drivers; updating of firmware; performance of hard and soft resets; and provision of a command-line interface.

The DUI may facilitate “time to market” for multi-nodal server class systems by providing a set of tools for developers to accelerate integration of firmware with the rest of the multi-nodal computer system. For example, some DUI functions might be tightly integrated with firmware debugger functions that may be GNU debugger (GDB), a non-UNIX™ debugger, or low-level firmware based.

Some embodiments of the DUI may resolve a conflict in the need to have a standard user interface for productivity of technical support and a need to have a non-standard user interface for developers. In some embodiments these conflicts are resolved by separating the DUI from an end customer-visible user interface (UI), and by making commands that are functionally identical in both the DUI and customer-visible UI, identical in syntax. Thereby, documentation and training may be facilitated.

Some embodiments of the DUI provide an interface to make the main registers of the processor more easily accessible. In one embodiment, when a failure tree analysis (FTA) case is encountered, the DUI makes a dump of the main registers of the processor. This enables an engineer or developer to look at a link map, or the like, to find out where the error occurred and thus facilitate determining a probable cause of the error. This enables more effective debugging by looking at the processor register state at the time the error occurred. Not only does the DUI of this embodiment automatically print a register dump, but it provides an interface to issue any DUI commands available to help troubleshoot a problem, as well as an ability to attach to a debugger.

Use of the DUI may depend upon who is employing it. By way of example, if there is a memory initialization error, and it is fatal to a degree where one or more cells cannot join with the other cells at rendezvous to boot the operating system, in accordance with one embodiment of the cell and/or system firmware will recognize that an error has occurred, and pass control to a DUI prompt or shell. At that point, a developer may make use of commands such as a GDB command to have source level debugging capability at that point in the boot process.

A field support engineer may invoke the DUI or employ the DUI to see if there are any configuration variables that may be set. In one embodiment the DUI enables the use of several commands that a firmware engineer or the like may employ to check the state of different parts of the cell. Upon cell level boot failure, an engineer may change state and data structures such that hardware is reconfigured or deconfigured. For example, defective memory may be taken out to reset a cell. As a result, if the other cells of the system are waiting at a point in the system boot, the cell may join in the boot process.

The present invention, in one embodiment, makes one console per node, or per cell, available. The system firmware may be written to use this capability. One or more of a plurality of embodiments of the present invention may be built into a multi-nodal or cellular architecture computer system. One embodiment uses a dedicated universal asynchronous receiver-transmitter (UART) chip, which may be built into the cell, such that it is a resource that belongs to the cell such that the cell firmware retains ownership of the UART exclusive of the OS thereby avoiding conflicts. In other words, the UART is a resource that belongs to a cell that may be used by that cell without alerting the system of such use. The UART is used when needed and the end-customer user of the system may be unaware of its existence. On a high end multi-nodal computer, the cost of an additional UART chip may be justified by the days of debugging that may be saved during system set up and/or installation. Another embodiment enables remote access to the DUI employing a collaborative effort with a firmware manageability and/or utility subsystem that may take the form of firmware that acts as an external interface for a cell or the system. Such a remote access system is disclosed in detail in co-pending, incorporated U.S. patent application Ser. No. [Attorney Docket No. 200207437-1], entitled “REMOTE ACCESS TO A FIRMWARE DEVELOPER USER INTERFACE”.

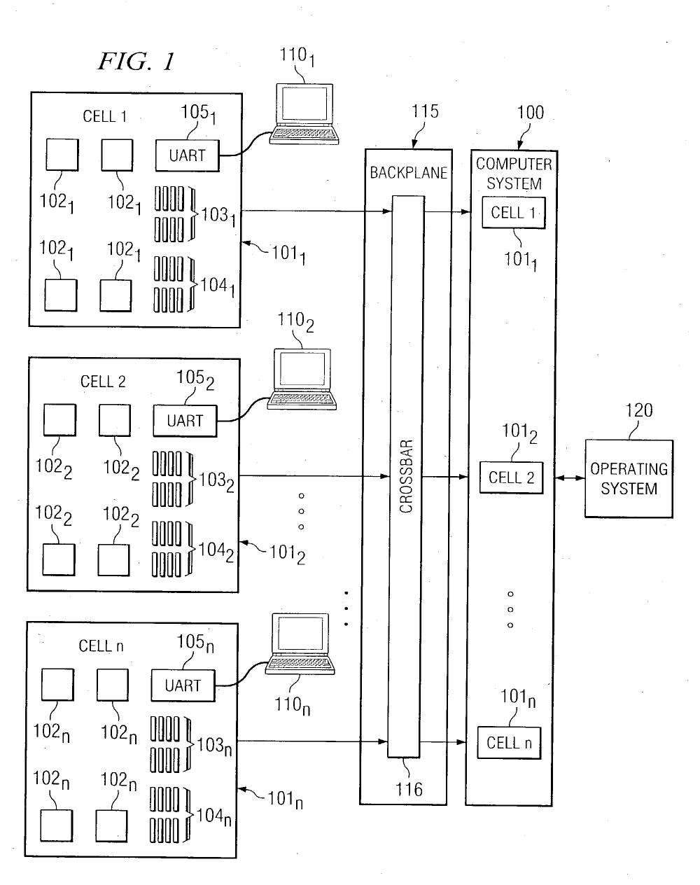

FIG. 1 diagrammatically illustrates the hardware layout of multi-nodal, or cellular architecture, computer system 100 employing the present systems and methods. FIG. 1 also illustrates flow of booting operations of system 100, as well. Individual cells 101₁ through 101ₙ are shown. Each cell typically consists of multiple processors 102 and its own memory 103. Each cell 101₁-101ₙ is typically a computer in its own right. Firmware 104 runs on each cell, until rendezvous, then firmware in a designated “core” cell handles system booting. Each cell, in one system embodiment, is interconnected to backplane 115. Crossbars 116, chips on the backplane, allow each cell to communicate with other cells connected to backplane 115. Each cell has a connection via UART 105₁-105ₙ, and a port or the like, to console 110₁-110ₙ where a developer or engineer can interact with each particular cell, another cell or entire system 100 employing the DUI.

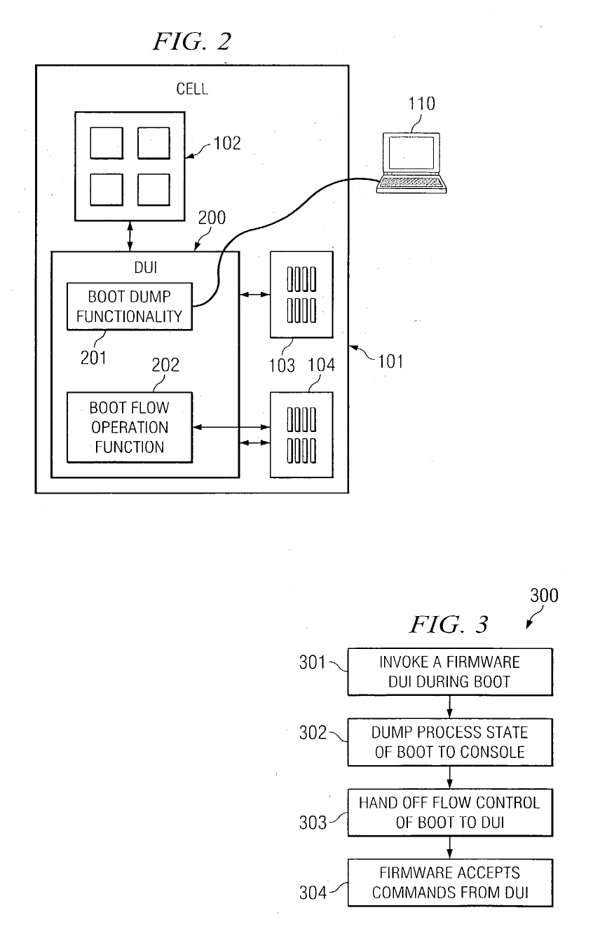

FIG. 2 shows an embodiment of firmware developer user interface 200 for a multi-nodal computer system operating in conjunction with cell 101 (i.e. cells 101₁-101ₙ of FIG. 1). DUI 200 comprises functionality 201 to receive a dump of boot process status of at least one cell of a multi-nodal computer system such as computer system 100. The dump may be displayed on a console of system 100, such as console 110 (110₁-110ₙ of FIG. 1), or a terminal directly or remotely networked with system 100 or a cell (101₁-101ₙ) of system 100. Flow of boot of at least one cell of the multi-nodal computer system may be controlled by a functional operation 202 of DUI 200. DUI 200 may be used to direct commands to firmware 104 of at least one cell (101₁-101ₙ) of multi-nodal computer system 100, using a console (such as consoles 110₁-110ₙ) or a networked terminal used by DUI 200 for display of the orientation boot process dump. Functionality 201 and boot flow control operation 202 may employ cell elements such as firmware 104, one or more processors 102 and/or memory 103 (i.e. firmware 104-104ₙ, processors 102₁-102ₙ and memory 103₁-103ₙ of FIG. 1).

Returning to FIG. 1, in the boot of system 100, each cell 101₁-101ₙ has individual firmware 104₁-104ₙ that runs on that cell up to a point, and then at a certain point in the boot process, a core cell, or primary cell, in the system takes over and boots system 100 as a whole. So there are a collection of cells after rendezvous before handing off to OS 120. The core cell handles the boot process after rendezvous and handoff to OS 120. Use of the present inventive DUI arises if an error occurs in a particular cell or in the rendezvoused cell set, prior to handoff to OS 120.

By way of example, if cell 101₁ has a memory or CPU error resulting in a MCA, the state of the boot process for that cell would be dumped to the screen of console 110₁, and control would be handed off to the DUI at console 110₁ over UART 105₁. At that point, the user, such as an engineer or developer may have a capability to interact with cell 101₁. The user may dump a state of particular components of cell 101₁; the user may “peek and poke” memory locations at low levels; or attach a debugger, such as GDB, and interact with cell elements to perform source level debugging of firmware 104₁, for cell 101₁. If the problem with cell 101₁ can be addressed at that point, the cell may be put back into the boot process if cells 101₂-101ₙ are waiting for cell 101₁, at a rendezvous point, and system 100 will still boot to OS 120. In the present example, if errant cell 101₁, is attached to critical resources such as the operating system boot disk or the like, cells 101₂-101ₙ would typically wait. Alternatively, cells 101₂-101ₙ may boot to OS 120 and cell 101₁ may be added online at a later time.

In accordance with an embodiment of the present invention, firmware interaction capability enables an error response mode to be set in the firmware, indicating whether cells should wait, or whether system 100 should pick another cell to act as the core cell. Alternatively, such firmware interaction capability may allow a setting that calls for cells to wait for a particular amount of time to allow a tardy cell to join the rendezvous before rebooting system 100.

Control may be passed to the DUI in a plurality of different manners, in accordance with embodiments of the present invention. The primary manner discussed herein is that flow control may be passed to the DUI in an error scenario. That is, if an error occurs that is fatal enough to the boot process that the boot process is stopped, the boot process state is dumped to the console screen and flow control is handed over to the DUI. Another manner to invoke the DUI is by issuing a break command from the console. This break command may be in the form of a keystroke combination. Yet another manner to enter the DUI is through a breakpoint (bp) command from the DUI. These latter two manners are disclosed in detail in co-pending, incorporated U.S. patent application Ser. No. [Attorney Docket No. 100200765-1], entitled “FIRMWARE DEVELOPER USER INTERFACE WITH BREAK COMMAND POLLING”.

Turning to FIG. 3 a flowchart of an embodiment of method 300 for providing a firmware developer user interface in a multi-nodal computer system is shown. Method 300 comprises invoking a firmware developer user interface during boot of a multi-nodal computer system at 301. At 302 a process state for the boot is dumped to a console of the multi-nodal computer system, or to a terminal locally or remotely networked to the system. Flow control of the boot may be handed off to the developer user interface at 303. Acceptance of commands issued to the firmware of the multi-nodal computer system, by a user of the developer user interface of the console or terminal may occur at 304.

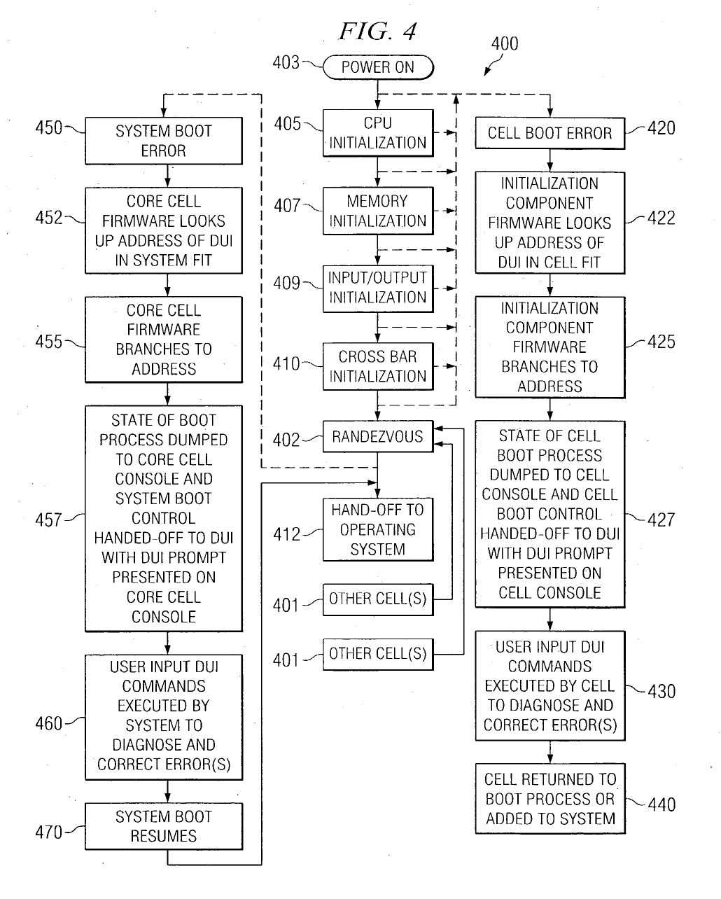

FIG. 4 is a flowchart of an example multi-nodal system boot 400, showing how firmware may initialize a multi-nodal system and where the DUI may be invoked due to a boot error or failure, such as an MCA. Booting of one cell is shown with other cells 401 joining that cell in boot 400 at rendezvous 402. The system powers on at 403. The CPUs in the cell may be initialized at 405. Following may be cell memory initialization 407, that may in turn be followed by cell I/O initialization 409. Then the system crossbars may be initialized at 410 enabling inter-connection of the cells. Crossbar initialization 410 establishes communication channels between the cell and the crossbar chip(s) that facilitate(s) communication between the other cells. This enables all the cells, at system level, to communicate with each other across the backplane. Once the crossbars are initialized the cells may join at rendezvous 402 and the system is then handed off to the OS at 412.

FIG. 4 is a high level diagram showing access before major component initialization. At almost any point within boot process 400 boot of a cell, prior to rendezvous 402, or boot of the system, prior to OS hand-off 412, may fail. The DUI may be given control on unrecoverable errors to give a firmware engineer or developer access to an otherwise “dead” cell prior to rendezvous 402 or to system resources such as may reside in the core cell after rendezvous 402, prior to OS handoff at 412.

Power up 403, CPU initialization 405, memory initialization 407, I/O initialization 409 and crossbar initialization 410 are all related to a particular cell's boot process. So if boot failure occurs at 420 during or between these events, there is no effect on booting of other cells. Work may be carried out, such as debugging on the interrupted cell, with no affect on the state or operation of the other cells 401. A boot failure after crossbar initialization 410, but before rendezvous 402 may enable access to any of the cells from one console. After all the cells have rendezvoused a boot failure at 450 may enable access to all or any of the cells in the system, as well as to the system itself, before handing-off the system to the operating system at 412.

In a multi-nodal system, the firmware within each cell may have several components, for example, a component that handles different CPU processes and initialization, a memory process initialization component, an I/O process initialization component and the like. These components include a FIT that provides memory locations that are essentially hard-coded memory locations to where control may pass. Following a cell boot error at 420 the initialization component firmware active at the time of the boot error may look up the address of the cell's DUI in the cell's FIT in step 422. The active initialization component firmware branches to the DUI address from the FIT at 425. The present state of boot process 400 is dumped to the cell console and the active initialization component hands control of the cell's boot process off to the DUI at 427. Also at 427 a DUI prompt in the form of a command line prompt or a shell prompt is presented on the cell console. Thus the DUI takes control of boot process 400 and waits for feedback from the engineer/developer user, via the console. At 430 the firmware engineer or developer may input DUI commands, such as those discussed below, via the console to diagnose and/or address the cell boot failure. Once the cause(es) of the cell boot failure are corrected, the cell may be allowed to continue to boot to either make rendezvous 402, or once boot of the cell is completed the cell may be added to the system online at step 440.

Invocation of the DUI during a boot error at 450, following rendezvous 402 but prior to hand-off to the operating system at 412 is handled somewhat differently than invocation during a cell boot failure at 420. For example, the core cell firmware may look up the address of the DUI in the system FIT, which may reside in the core cell's firmware, at 452. The core cell firmware may then branch to the DUI address at 455. The present state of boot process 400 may be dumped to the core cell's console, control of boot process 400 may be handed off to the DUI, and a DUI prompt or shell prompt is presented on the cell console, at 457. At 460 the firmware engineer or developer may input DUI commands, via the console. These commands may be executed by the system to enable diagnosing and/or correcting the boot failure. Once the cause(es) of the boot failure are discovered and corrected, the system may be allowed to continue to boot, at 470.

In accordance with embodiments of the present invention, the DUI acts as a command line prompt, similar to a DOS prompt or the like, querying the user via the console for commands. Alternatively, a user interface shell may be presented. Regardless, the DUI has a set of commands that a user may employ and the DUT may offer a help command that lists and/or explains available commands. The DUI may also have a “reset” command so that the user is able to reset a cell or the system from the DUI prompt. The point in the boot process where the DUI is accessed may determine whether it may reset only a cell or the entire system. According to an embodiment of the present invention, if the DUI is accessed during cell initialization for a particular cell, it may reset that cell; if the DUI is accessed after cell rendezvous, it may reset the entire multi-nodal system.

Another command that may be available through the DUI is a tree command. The tree command enables the engineer/developer user to dump a list of all the components that have been installed in the firmware data structures up to the point of invocation of the DUI. The tree command returns a tree structure so that the user can see subparts of initialization steps, so for example, an 1/0 component might be displayed with different PCI cards below it in a hierarchical fashion. That allows the user to see what has been installed or initialized to the point of DUI invocation. There are commands associated with the tree command such as “get prop”, “set prop”, “delete prop” and “find prop”. These enable a user to access different data structures for individual properties of a cell. A property is essentially a data structure with information associated with a component in the cell. The tree also may act as a type of directory structure for the firmware. So if the tree command is issued from the “root” of the tree it will show the entire tree. Through the use of commands such as “cd” and “ls” and the like, a user may traverse the tree similar to a disk directory structure on a PC, or a UNIX system. For example, a user may “cd” into a directory or the next tree node below the user's location or use the “cd” command and give a path to a tree node to enter. Once the user is at that point in the tree structure he or she has access to all the different data structures' in that tree node. A call method command calls a particular function on a tree node of the boot process state of a cell.

Another set of commands are the “peek” and “poke” commands. These allow low level access to the memory that has been initialized up to invocation of the DUI. The peek and poke commands may be used to view and control status registers within individual chips on a board within a cell. Other diagnostic commands available to the DUI may include dump control status registers for displaying control status registers of the cell and modify control status registers for changing a value of a control status register of the cell. Dump random access memory displays contents of non-volatile random access memory of the cell and error dump displays error logs encountered during a boot of the cell. A generate machine check abort command may be used for generating a test machine check abort in the cell. Main shift register read or write commands may enable reading or writing a value of a central processing unit of the cell's main shift register. A platform abstraction layer procedure command calls a platform abstraction layer procedure of the cell, while peripheral component interconnect (PCI) read and PCI write commands enable reading and writing data in a PCI memory space of the cell. A show stack command shows stack usage of a central processing unit in the cell.

The DUI may employ a command known as “invalnvm” to invalidate headers in the NVRAM, such that in a subsequent reboot, NVRAM is wiped clean and reinitialized during that subsequent boot. This command may be used to eliminate any erroneous settings in the NVRAM. Other configuration commands include “CPU config” for configuring and deconfiguring CPUs of a cell, and a dual inline memory module (DIMM) configuration command for configuring and deconfiguring DIMMs in a cell.

A “bp” command may be used to set breakpoints at different points in the cell or system boot. The “bp” command sets values in the NVRAM so a combination of using “bp” “invalnvm” may be used to clear breakpoints. However, the “bp” command may both set and clear breakpoints, essentially toggling the breakpoints at a location.

The GDB command may be used as an interrupt that allows the GNU debugger to attach from a different console to the firmware of a cell. A “malloc” command shows how much memory has been “malloced”, or allocated for a particular use by programs, in the cell or the system at a particular point in the boot process.

What is claimed is:

1. A method for providing a firmware developer user interface in a multi-nodal computer system, said method comprising:
invoking a firmware developer user interface during boot of a multi-nodal computer system;
dumping a process state for said boot to a console;
handing-off flow control of said boot to said developer user interface; and
accepting at least one command to firmware of said multi-nodal computer system via said console and said developer user interface.

2. The method of claim 1 wherein said invoking occurs upon boot failure.

3. The method of claim 2 wherein said boot failure occurs within a cell of said multi-nodal computer system.

4. The method of claim 3 wherein said console is a console of said cell.

5. The method of claim 3 wherein said boot process state is a boot process state of boot of said cell.

6. The method of claim 3 wherein said flow control is flow control of said boot of said cell.

7. The method of claim 3 wherein said firmware is firmware of said cell.

8. The method of claim 1 wherein said invoking further comprises breaking said boot by a developer user.

9. The method of claim 8 wherein said breaking further comprises keying a break keystroke combination.

10. The method of claim 1 wherein said dumping further comprises presenting said boot process state in a hierarchical tree structure on said console.

11. The method of claim 1 wherein said firmware developer user interface provides a command line prompt displayed on said console.

12. The method of claim 1 wherein said firmware developer user interface provides a command shell displayed on said console.

13. The method of claim 1 wherein said at least one command comprises at least one tree command selected from a group of tree commands consisting of:
change directory, for navigating a tree of said boot process state;
list, for listing elements of sad boot process state;
get property, for getting a data structure of a component property;
set property, for setting up a property data structure of a component;
delete property, for deletion a data structure of a component property; and
call method, for calling a particular function on a tree node.

14. The method of claim 1 wherein said at least one command comprises at least one diagnosis command selected from a group of diagnosis commands consisting of:
breakpoint, for inserting a break command to invoke said developer user interface;
peek, for viewing status registers within individual chips;
poke, for controlling status registers within individual chips;
debug, for attaching a debugger to said firmware;
malloc, for viewing how much memory has been allocated for particular uses by a program;
dump control status registers, for displaying control status registers;
modify control status registers, for changing a value of a control status register;
dump random access memory, for displaying contents of non-volatile random access memory;
error dump, for displaying error logs encountered during a boot;
generate machine check abort, for generating a test machine check abort;
main shift register read, for reading a value of a central processing unit's main shift register;
main shift register write, for writing a value to a central processing unit's main shift register;
platform abstraction layer procedure, for calling a platform abstraction layer procedure;
peripheral component interconnect read, for reading data from peripheral component interconnect memory space;
peripheral component interconnect write, for writing data to peripheral component interconnect memory space; and
show stack, for showing stack usage on a central processing unit.

15. The method of claim 1 wherein said at least one command comprises at least one configuration command selected from a group of configuration commands consisting of:
invalidate nonvolatile random access memory, for invalidating headers in firmware nonvolatile random access memory;
central processing unit configuration, for configuring and deconfiguring central processing units; and
dual inline memory modules configuration, for configuring and deconfiguring dual inline memory modules.

16. A firmware developer user interface for a multi-nodal computer system comprising:
means for receiving a dump of boot process status of at least one cell of a multi-nodal computer system;
means for displaying said dump on a console of said system;
means for controlling flow of boot of at least one cell of said multi-nodal computer system; and
means for directing commands to firmware of at least one cell of said multi-nodal computer system from said console.

17. The firmware developer user interface of claim 16 further comprising means for invoking said firmware developer user interface upon boot failure of said multi-nodal computer system.

18. The firmware developer user interface of claim 17 wherein said boot failure is a boot failure of a cell of said multi-nodal computer system.

19. The firmware developer user interface of claim 17 wherein said invoking means comprises means for breaking said boot by a developer user.

20. The firmware developer user interface of claim 19 wherein said breaking means is responsive to a break keystroke combination at said console.

21. The firmware developer user interface of claim 16 wherein said console is a console of a cell of said multi-nodal computer system.

22. The firmware developer user interface of claim 16 wherein said firmware developer user interface is presented as a command line prompt on said console of said system.

23. The firmware developer user interface of claim 16 wherein said firmware developer user interface is presented as a command shell on said console of said system.

24. The firmware developer user interface of claim 16 wherein said boot process state is displayed in a hierarchical tree structure on said console of said system.

25. The firmware developer user interface of claim 16 wherein said commands comprise at least one tree command selected from a group of tree commands consisting of:
change directory, for navigating a tree of said boot process state;
list, for listing elements of sad boot process state;
get property, for getting a data structure of a component property;
set property, for setting up a property data structure of a component;
delete property, for deletion a data structure of a component property; and
call method, for calling a particular function on a tree node.

26. The firmware developer user interface of claim 16 wherein said commands comprise at least one diagnosis command selected from a group of diagnosis commands consisting of:
breakpoint, for inserting a break command to invoke said developer user interface;
peek, for viewing status registers within individual chips;
poke, for controlling status registers within individual chips;
debug, for attaching a debugger to said firmware;
malloc, for viewing how much memory has been allocated for particular uses by a program;
dump control status registers, for displaying control status registers;
modify control status registers, for changing a value of a control status register;
dump random access memory, for displaying contents of non-volatile random access memory;
error dump, for displaying error logs encountered during a boot;
generate machine check abort, for generating a test machine check abort;
main shift register read, for reading a value of a central processing unit's main shift register;
main shift register write, for writing a value to a central processing unit's main shift register;
platform abstraction layer procedure, for calling a platform abstraction layer procedure;
peripheral component interconnect read, for reading data from peripheral component interconnect memory space;
peripheral component interconnect write, for writing data to peripheral component interconnect memory space; and
show stack, for showing stack usage on a central processing unit.

27. The firmware developer user interface of claim 16 wherein said commands comprise at least one configuration command selected from a group of configuration commands consisting of: invalidate nonvolatile random access memory, for invalidating headers in firmware nonvolatile random access memory;
central processing unit configuration, for configuring and deconfiguring central processing units; and
dual inline memory modules configuration, for configuring and deconfiguring dual inline memory modules.

28. A method for providing a firmware developer user interface in a multi-nodal computer system, said method comprising:
invoking a firmware developer user interface upon boot failure of a cell in a multi-nodal computer system;
dumping a process state for said boot of said cell to a console of said system;
handing-off flow control of said boot of said cell to said developer user interface; and
accepting at least one command to firmware of said cell via said console and said developer user interface.

29. The method of claim 28 wherein said dumping further comprises presenting said boot process state in a hierarchical tree structure on said console.

30. The method of claim 28 wherein said firmware developer user interface provides a command line prompt displayed on said console.

31. The method of claim 28 wherein said firmware developer user interface provides a command shell displayed on said console.

32. The method of claim 28 wherein said console is a console of said cell.

33. The method of claim 28 said at least one command comprises at least one tree command selected from a group of tree commands consisting of:
change directory, for navigating a tree of said boot process state of said cell;
list, for listing elements of sad boot process state of said cell;
get property, for getting a data structure of a component property of said cell;
set property, for setting up a property data structure of a component of said cell;
delete property, for deletion a data structure of a component property of said cell; and
call method, for calling a particular function on a tree node of said boot process state of said cell.

34. The method of claim 28 wherein said at least one command comprises at least one diagnosis command selected from a group of diagnosis commands consisting of:
breakpoint, for inserting a break command to invoke said developer user interface;
peek, for viewing status registers within individual chips of said cell;
poke, for controlling status registers within individual chips of said cell;
debug, for attaching a debugger to said firmware; of said cell malloc, for viewing how much memory has been allocated for particular uses by a program of said cell;
dump control status registers, for displaying control status registers of said cell;
modify control status registers, for changing a value of a control status register of said cell;
dump random access memory, for displaying contents of non-volatile random access memory of said cell;
error dump, for displaying error logs encountered during a boot of said cell;
generate machine check abort, for generating a test machine check abort of said cell;
main shift register read, for reading a value of a central processing unit of said cell's main shift register;
main shift register write, for writing a value to a central processing unit of said cell's main shift register;
platform abstraction layer procedure, for calling a platform abstraction layer procedure of said cell;
peripheral component interconnect read, for reading data from peripheral component interconnect memory space of said cell;
peripheral component interconnect write, for writing data to peripheral component interconnect memory space of said cell; and
show stack, for showing stack usage on a central processing unit of said cell.

35. The method of claim 28 wherein said at least one command comprises at least one configuration command selected from a group of configuration commands consisting of:
invalidate nonvolatile random access memory, for invalidating headers in firmware nonvolatile random access memory of said cell;
central processing unit configuration, for configuring and deconfiguring central processing units of said cell; and
dual inline memory modules configuration, for configuring and deconfiguring dual inline memory modules of said cell.

36. A firmware developer user interface for a multi-nodal computer system comprising:
means for receiving a dump of boot process status of a cell of a multi-nodal computer system;
means for displaying said dump on a console of said system;
means for controlling flow of boot of said cell; and
means for directing commands to firmware of said cell from said console.
